(19) United States
(12) Patent Application Publication
(10) Pub. No.: US 2026/0012281 A1
(43) Pub. Date: Jan. 8, 2026

(54) MULTI-STAGE RECONFIGURABLE ADD-DROP MULTIPLEXER

(71) Applicant: HUAWEI TECHNOLOGIES CO., LTD., Shenzhen (CN)

(72) Inventors: Hamid MEHRVAR, Kanata (CA); Shiqiang LI, Kanata (CA); Ruishan CHEN, Kanata (CA)

(21) Appl. No.: 19/327,301

(22) Filed: Sep. 12, 2025

Related U.S. Application Data
(63) Continuation of application No. PCT/CN2023/099122, filed on Jun. 8, 2023.

(51) Int. Cl. H04J 14/02

(52) U.S. Cl. CPC H04J 14/02122

(57) ABSTRACT

Reconfigurable optical add-drop multiplexers (ROADMs) includes D optical inputs that receive optical signals, D first optical switching devices, each first optical switching device being associated with one of the D optical inputs, second optical switching devices associated with one of the outputs of a corresponding first optical switching device, each second optical switching device fans-out the optical signal into N multiple signals, third optical switching devices, that combine second output signals received from a corresponding M=D|N of the second optical switching devices, and combining devices that, in use, combine third output signals of N corresponding third optical switching devices and provide a set of D optical outputs of the ROADM and a controller communicably connected to the first, second, third and f [symbol] th optical switching devices to adjust a switching state thereof.

### CROSS-REFERENCE

The present application is a continuation of International Patent Application No. PCT/CN2023/099122, entitled “Multi-Stage Reconfigurable Add-Drop Multiplexer,” filed Jun. 8, 2023, the entirety of which is incorporated by reference herein.

### TECHNICAL FIELD

The present technology pertains to the field of network communications, and in particular, to multi-stage reconfigurable add-drop multiplexers.

### BACKGROUND

Existing fiber optic networks use optical nodes including reconfigurable optical add-drop multiplexer (ROADM) to perform various functions on various wavelengths of optical signals. Among other functions, ROADMs add, drop and redirect wavelengths. Accommodating sustained exponential traffic growth in optical networks requires capacity scaling and adding multiple pairs of bi-directional fibers on the links of an optical network. To enable scaling and adding capacity per demand, a number of nodes and capability of an optical network need to be enhanced. In other words, optical switches, such as reconfigurable add-drop multiplexers (ROADMs), need to increase the number of their bi-directional fibers (or degrees).

However, existing ROADMs offer limited degrees that may be applied to a wavelength for redirection. Further, existing ROADMs offer limited add-drop rates for adding and/or dropping wavelengths. Existing ROADMs may be unable to meet increasing network capacity demand. In addition, stakeholders of optical networks including vendors and customers have already invested substantially in existing ROADMs that are not only expensive but also have long life spans and could not economically be removed from existing networks.

Because of the challenges and costs associated with expanding size of wavelength selective switches (WSS), which are a common component of the ROADMs, some current technologies use a same WSS size to scale up ROADMs. For instance, some technologies provide large ROADMs by exploiting nodal degree bundling to selectively reduce degree connectivity and allow the same WSS size to be used for larger ROADMs. These technologies may increase the number of directions of a ROADM, but they sacrifice the directionless feature of a ROADM, hence, degrading the switching performance of the scaled ROADM.

Therefore, there is an interest a method and apparatus for improving the existing ROADMs functionalities to better meet the increased network demands and obviates or mitigates one or more limitations of the prior art.

### SUMMARY

The implementations of the present disclosure have been developed based on developers' appreciation of the limitations associated with the prior art.

In accordance with a first broad aspect of the present disclosure, there is provided a reconfigurable optical add-drop multiplexer including a first stage comprising a set of D first optical switching devices, each first optical switching device being configured to receive a corresponding optical signal, each first optical switching device being configured to distribute wavelengths of the corresponding optical signal over a plurality of corresponding outputs, a second stage comprising a set of second optical switching devices, each second optical switching device being associated with one of the outputs of a corresponding first optical switching device and configured to receive a first output optical signal therefrom, each second optical switching device being configured to fan-out the first output optical signal into N multiple signals, where N is an integer equal to or greater than 2, a third stage comprising a set of third optical switching devices, each third optical switching devices being configured to combine second output signals received from M=D|N corresponding second optical switching devices, a combination performed by a given third optical switching device being based on a switching state thereof, a fourth stage comprising a set of D combining devices configured to combine, in use, third output signals of N corresponding third optical switching devices and provide a set of D optical outputs of the reconfigurable optical add-drop multiplexer, and a controller communicably connected to the optical switching devices of the first and third stages and to the combining devices of the fourth stage to adjust switching states thereof.

In some non-limiting implementations, at least one of the second optical switching devices is a wavelength selectable switch.

In some non-limiting implementations, at least one of the second optical switching devices is an optical splitter.

In some non-limiting implementations, each first optical switching device includes zero or more drop output channel.

In some non-limiting implementations, D×(O−Drop)=K, where O is a number of outputs of a particular first optical switching device, Drop is a number of drop output channels of the particular first optical switching device, and K is a number of second optical switching devices corresponding to the particular first optical switching device.

In some non-limiting implementations, each third optical switching device includes zero or more add input channel.

In some non-limiting implementations, the first optical switching devices are partitioned into a plurality of sub-sets, the second optical switching devices associated with a first sub-set of the first optical switching devices fan-out their signals to a first sub-set of third optical switching devices, the second optical switching devices associated with a second sub-set of the first optical switching devices fan-out their signals to a second sub-set of the third optical switching devices, and at least one of the combining devices is configured to combine a first signal received from a third optical switching device of the first sub-set of third optical switching devices with a second signal received from a third optical switching device of the second sub-set of third optical switching devices.

In some non-limiting implementations, the reconfigurable optical add-drop multiplexer further includes a plurality of optical line cards, each optical line card including a given first optical switching device, at least two third optical switching devices receiving signals from the second optical switching devices associated with the given first optical switching device and at least one of the combining devices of the fourth stage. The reconfigurable optical add-drop multiplexer further includes a plurality of backplane chassis communicably connected to one another, each backplane chassis being configured to receive a sub-set of the plurality of optical line cards, a first backplane chassis being configured to host the optical line cards of the first sub-set of the first optical switching devices and a second backplane chassis being configured to host the optical line cards of the second sub-set of the first optical switching devices.

In some non-limiting implementations, the first optical switching devices are wavelength selectable switches.

In some non-limiting implementations, the reconfigurable optical add-drop multiplexer further includes a set of D optical inputs, each optical input being configured to receive a corresponding optical signal, each first optical switching device being associated with one of the D optical inputs and configured to receive the corresponding optical signal therefrom.

In some non-limiting implementations, the set of D optical inputs includes 60 optical inputs, the first stage includes 60 first optical switching devices, each first optical switching device is a 1×32 wavelength selectable switch including two drop output channels, the second stage includes 1800 second optical switching devices, each second optical switching device is configured to fan-out the signal into two signals, the third stage includes 120 third optical switching devices, and the fourth stage includes 60 combining devices.

In some non-limiting implementations, the set of D optical inputs includes 120 optical inputs, the first stage includes 120 first optical switching devices, each first optical switching device is a 1×32 wavelength selectable switch including two drop output channels, the second stage includes 3600 second optical switching devices, each second optical switching device is configured to fan-out the signal into four signals, the third stage includes 240 third optical switching devices, and the fourth stage includes 120 combining devices.

In some non-limiting implementations, the set of D optical inputs includes 120 optical inputs, the first stage includes 120 first optical switching devices, each first optical switching device is a 1×64 wavelength selectable switch including four drop output channels, the second set stage includes 7200 second optical switching devices, each second optical switching device is configured to fan-out the signal into two signals, the third stage includes 240 third optical switching devices, each third optical switching devices includes two add input channels, and the fourth set of combining devices includes 120 combining devices.

In some non-limiting implementations, the reconfigurable optical add-drop multiplexer further includes an add-drop module operably connected to each of the first and third optical switching device such that the add-drop module may receive drop signals therefrom and transmit add signals thereto.

### BRIEF DESCRIPTION OF THE DRAWINGS

An object of implementations of the present technology is to provide a method and apparatus for a high-degree reconfigurable add-drop multiplexer (ROADM). The features and advantages of the present disclosure will become apparent from the following detailed description, taken in combination with the appended drawings, in which:

FIG. 1 is an example of an existing chassis for a ROADM;

FIG. 2 is an illustration of an optical backplane interconnecting the slots of chassis of FIG. 1;

FIG. 3 is an illustration of a line chassis, an add-drop chassis, and an interconnect chassis of a ROADM cluster, according to an implementation of the present disclosure;

FIG. 4 illustrates a high degree ROADM node configuration according to an implementation of the present technology;

FIG. 5 illustrates a high degree ROADM node configuration according to another implementation of the present disclosure;

FIG. 6 illustrates the high degree ROADM node configuration of FIG. 4 implemented in optical line cards according to an implementation of the present technology;

FIG. 7 illustrates optical connections of chassis of the high degree ROADM node configuration of FIG. 4;

FIG. 8 illustrates a high degree ROADM node configuration according to yet another implementation of the present disclosure;

FIG. 9 illustrates a high degree ROADM node configuration according to yet another implementation of the present disclosure; and

FIG. 10 is a block diagram of a controller of the high degree ROADM node configuration of FIGS. 4, 5, 8 and 9 according to some implementations of the present technology.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims.

### DETAILED DESCRIPTION

Unless otherwise defined or indicated by context, all technical and scientific terms used herein have the same meaning as commonly understood by one of ordinary skill in the art to which the described implementations appertain.

Various representative implementations of the described technology will be described more fully hereinafter with reference to the accompanying drawings, in which representative implementations are shown. The present technology concept may, however, be embodied in many different forms and should not be construed as limited to the representative implementations set forth herein. Rather, these representative implementations are provided so that the disclosure will be thorough and complete, and will fully convey the scope of the present technology to those skilled in the art. In the drawings, the sizes and relative sizes of layers and regions may be exaggerated for clarity.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “controller”, “processor”, “pre-processor”, or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processor” and “third processor” is not intended to imply any particular order, type, chronology, hierarchy or ranking (for example) of/between the processor, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” processor and a “second” processor may be the same software and/or hardware, in other cases they may be different software and/or hardware.

In the context of the present specification, when an element is referred to as being “associated with” another element, in certain implementations, the two elements can be directly or indirectly linked, related, connected, coupled, the second element employs the first element, or the like without limiting the scope of the present disclosure.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

With these fundamentals in place, the instant disclosure is directed to address at least some of the deficiencies of the current technology.

A reconfigurable add-drop multiplexer (ROADM) is an optical node that adds, blocks, passes or redirects optical signals of various wavelengths in a fiber optic network, or simply “network”. ROADMs may be used in communication systems that employ wavelength division multiplexing allowing data traffic modulated on a wavelength to be added at a source ROADM and then passed through one or many ROADMs before the data traffic is dropped at a destination ROADM. Once dropped, the destination ROADM may demodulate the optical signal and decode the data into electronic bits.

In the context of the present disclosure, a degree of a ROADM, or “ROADM”, is a total number of fiber link pairs connected to a ROADM. Given a capacity of standard fibers and current trend of increasing traffic, network operators add multiple single-mode fibers or multi-core fibers to their network. With the deployment of each new fiber, the degree of the ROADMs changes due to the implementation of a new optical multiplex section between a head ROADM and an end ROADM of an optical communication link.

The addition of new optical multiplex sections creates scaling challenges for the operators. This is because the size of a key component in the design of a ROADM, i.e., wavelength select switch (WSS), is limited today to a maximum of 1×32, hence the number of degrees that a ROADM can offer may be bounded. It may be challenging and expensive to expand a size of a WSS, in part because of a limited steering angle of liquid crystal on silicon technology. As a result, a common strategy has been to use small-size WSSs to build high-degree ROADM. An aspect of the present technology is to provide a high-degree optical ROADM with a scalability from tens to hundreds of degrees using existing WSS, flexibility in adding or dropping wavelength connections up to 100% of node capacity, while minimizing the scaling cost and maximizing the rate of return for the network operators.

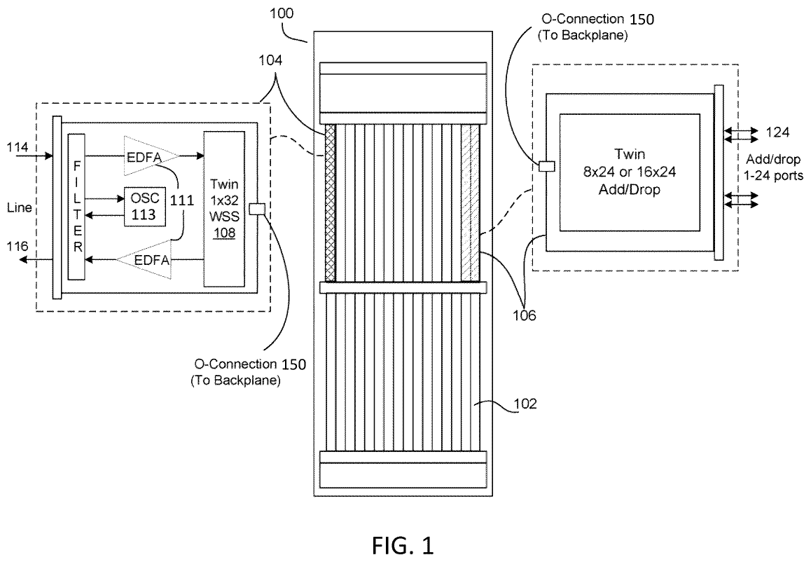

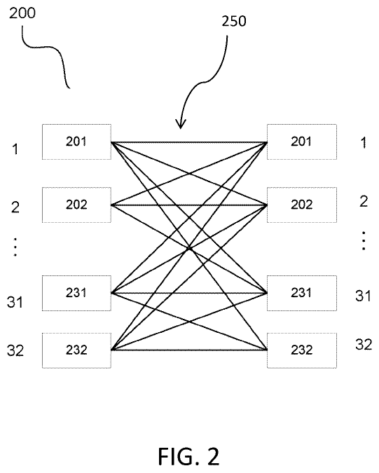

FIG. 1 is an example of a chassis 100 for a ROADM. The chassis 100 may include 32 slots 102 for holding and/or inserting one or more optical line cards 104 and one or more add-drop tributary cards 106. Each slot 102 may be fully interconnected to the other 31 slots through an optical backplane 200 (see FIG. 2).

The optical line cards 104 may perform line functionality as it may be interconnected to other ROADMs. The add-drop tributary cards 106 process the dropped wavelengths to a node or add a traffic channel on a wavelength of an optical line card 104.

The total degree of a ROADM is the total number of fiber pairs connected to the ROADM. Each fiber pair connects with an optical line card 104, one fiber on the receiving side 114 and one fiber on the transmitting side 116.

Each line card 104 occupies a single slot 102 of the chassis 100. Each line card 104 (each slot 102) may comprise one fiber pair indicating one direction, both ways. The optical line card 104 may comprise two 1×32 wavelength select switch (WSS) 108, one on the receiving side 114 and another on the transmitting side 116. The optical line card 104 may further comprise two erbium-doped fiber amplifiers (EDFA) 111 and a circuitry for Optical Service Channel (OSC) 113. On the receiving side, the WSS 108 can extract up to 80 wavelengths and distribute each wavelength at any of its 32 outputs. In some instances, the WSS 108 can extract up to 96 wavelengths in C-band, or up to 240 wavelengths for C+L bands. Provided that each line card is fully interconnected with the other line cards, any one or more wavelengths received at each line card may be transmitted to any one or more of the other line cards (directions) through the one or more of the 32 outputs. For example, each slot may be interconnected with the other slots through O-connection 150 established in an optical backplane of the chassis 100. Since each slot 102 may be fully interconnected to the other 32 slots through optical connections 250 defined in the backplane 200, the interconnection between the slots 102 allows for full mesh interconnectivity between the optical line cards 104.

Each add-drop tributary card 106 may occupy 2 slots 102. The add-drop card 106 may include, for example and without limitation, 24 add-drop ports 124 allowing for up to 24 wavelengths to be added to or dropped at the ROADM. Each optical line card 104 may be optically interconnected to each of the add-drop cards 106 through the optical backplane 200.

FIG. 2 is an illustration of an optical backplane 200 interconnecting the slots of chassis 100 of FIG. 1. Referring to FIG. 2, the 32 slots 102 may be represented by slots 201, 202 . . . 231 and 232. Each slot 102 may be connected to the other 31 slots and to itself through the optical backplane 200. For example, slot 201 is interconnected with the other 31 slots (202 . . . 231 and 232) through the O-connection 250 established by the optical backplane 200. Accordingly, each optical line card 104 placed in slots 102 may be interconnected with each of the other optical line cards 104 and with each add-drop card 106 placed in slots 102. Similarly, each add-drop card 106 placed in slots 102 may be interconnected with each of the other add-drop cards 106 and with each line card 104 placed in slots 102. Connections between the optical line cards 104 are described in greater details herein after in accordance with some implementations of the present technology.

In some implementations, the chassis 100 may be used to design an 8-degree ROADM. For an 8-degree ROADM, the chassis 100 may comprise 8 line cards 104 occupying 8 slots 102. The remaining 24 slots (32 total slots minus 8 slots used for 8 line cards 104) may be used for 12 add-drop tributary cards 106, each occupying two slots 102. Accordingly, the number of add-drop wavelengths for an 8-degree ROADM may be 288 (calculated as 12 add-drop tributary cards times 24 wavelength/add-drop tributary card). Therefore, for the case of 96 wavelengths in each direction, the 8-degree ROADM may have an add-drop rate of 37.5% (i.e. 288 wavelengths/(8 line cards×96 wavelengths/line card)). And for the case of 80 wavelengths in each direction, the 8-degree ROADM may have an add-drop rate of 45% (i.e. 288 wavelengths/(8 line cards×80 wavelengths/line card)).

In other implementations, the chassis 100 may be used to design a 16-degree ROADM. For a 16-degree ROADM, the chassis 100 may comprise 16 line cards 104 occupying 16 slots 102. The remaining 16 slots (32 total slots minus 16 slots used for 16 line cards 104) may be used for 8 add-drop tributary cards 106, each occupying two slots 102. Accordingly, the number of add-drop wavelengths for the 16-degree ROADM may be 192 (i.e. 8 add-drop tributary cards times 24 wavelength/add-drop tributary card). Therefore, for the case of 96 wavelengths in each direction, the 16-degree ROADM may have an add-drop rate of 12.5% (i.e. 192 wavelengths/(16 line cards×96 wavelengths/line card)). And for the case of 80 wavelengths in each direction, the 16-degree ROADM may have an add-drop rate of 15% (i.e. 192 wavelengths/(16 line cards×80 wavelengths/line card)).

An incoming wavelength may be dropped through an add-drop card 106 of a ROADM. The wavelength having arrived at the optical line card of the ROADM is transferred, through the backplane 200, to the appropriate add-drop card 106 for dropping. The wavelength is then dropped through one of the add-drop ports 124, which may be connected to a router (not shown).

A wavelength may also be added to an outgoing wavelength of a ROADM though an add-drop card 106. A router (not shown) connected to an add-drop port 124 may send data to the add-drop card 106 such that said data is carried by an outgoing wavelength of the ROADM. The data may enter the add-drop card 106 through the add-drop port 124 and be converted to light and carried on an assigned wavelength. The wavelength may then be transferred through the optical backplane 200 to the appropriate line card 104 to be sent at the assigned wavelength of the appropriate direction associated with the optical line card 104.

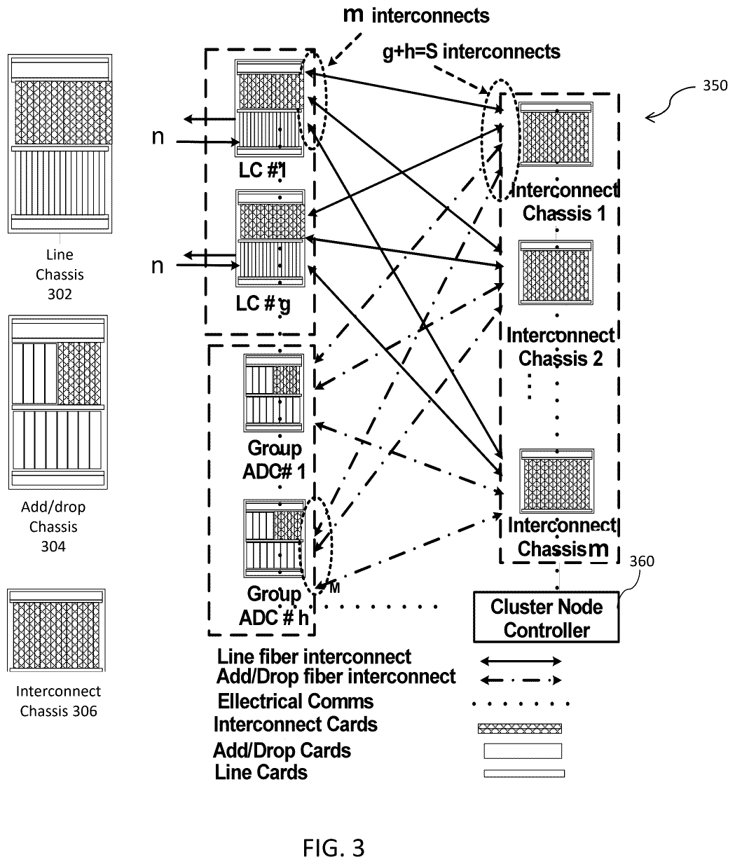

FIG. 3 is an illustration of a line chassis 302, an add-drop chassis 304, and an interconnect chassis 306 of a ROADM cluster, according to an implementation of the present disclosure. The ROADM cluster may include three sets of chassis, including one or more line chassis 302, one or more add-drop chassis 304, and one or more interconnect chassis 306. In more details, the ROADM cluster comprises a first set of at least one line chassis 302 for performing line functionality (i.e. wherein the at least one line chassis has no add-drop functionality), a second set of at least one add-drop chassis 304 for performing add-drop functionality (i.e. wherein the at least one add-drop chassis has no line functionality), and a third set of at least one interconnect chassis 306. In some implementations, the at least one line chassis 302 performs line functionality exclusively. Similarly, in some implementations, the at least one add-drop chassis 304 performs add-drop functionality exclusively. Connections between the chassis 302, 304 and 306 are not shown on FIG. 3, but will become apparent in the description of following Figures.

The line chassis 302 may for example comprise 32 slots 308 for housing WSS components including N optical line cards and M interconnect cards. Each line card may be similar to the optical line card 104. Each interconnect card may for example and without limitation be a twin 1×32 WSS card. Some of these optical line cards may be used to connect with external nodes (i.e., other ROADMs). The rest of the optical line cards may be used to interface internally with other components of the ROADM cluster. In some implementations, the line chassis 302 comprising 32 slots 308 may receive 32 cards. N of the 32 cards may be line cards and m=32-n of the 32 cards may be interconnect cards. Both line cards and inter-connect cards may be the same as far as hardware is concerned but their functions are different. Line cards are used for INTER-connectivity of the ROADM cluster to other ROADMs whereas inter-connect cards are used for INTRA-connectivity among the chassis within the ROADM cluster, the INTRA-connectivity referring to the 3 types of connectivity, mentioned above, among line and add-drop chassis of the ROADM cluster.

The interconnect cards may be used to interconnect each line chassis 302 to one or more of the interconnect chassis 306. The line chassis 302 may use the same chassis 100 as described herein. The line chassis 302 may further comprise an optical backplane (not shown), similar to the optical backplane 200, interconnecting the optical line cards and the interconnect cards.

The add-drop chassis 304 may for example comprise 32 slots 310 for housing WSS components including n/2 add-drop cards and m interconnect cards. It should be noted that the n/2 value is based on the size of currently available add-drop cards having double the width of the slots 310. Accordingly, the number of add-drop cards is dependent on the size of the add-drop cards, given that for a chassis comprising 32 slots 310 with m interconnect cards, the add-drop chassis may accommodate 32-m slots 310 for housing the add-drop cards. Accordingly, for add-drops that may only occupy one slot 310, then the add-drop chassis may comprise 32-m=n add-drop cards.

Each add-drop card may for example and without limitation be similar to add-drop card 106 and each interconnect card may be a twin 1×32 WSS card. The add-drop tributary cards are the transponder cards tuned to the wavelengths needed to be added to or dropped at the ROADM cluster. The interconnect cards may be used to interconnect the add-drop chassis 304 to each interconnect chassis 306. The add-drop chassis 304 may comprise the same chassis 100 described herein. The add-drop chassis 304 may further comprise an optical backplane, similar to optical backplane 200, interconnecting the add-drop cards and interconnect cards.

The interconnect chassis 306 are used for INTRA-connectivity among the components of the ROADM cluster, i.e., the line chassis 302 and the add-drop chassis 304. The interconnect chassis 306 may comprise S slots 312 for housing WSS components including S interconnect cards. The interconnect chassis 306 may further comprise an optical backplane (not shown) for interconnecting each interconnect card to one or more of the other S-1 interconnect cards. In some implementations the interconnect chassis may be a chassis similar to one used for line chassis, such as the chassis 100. In other implementations the interconnect chassis may use a common equipment low-cost chassis, which may be based on a twin 1×16 WSS. In such a case, S may be 16, and accordingly, the interconnect chassis may comprise 16 slots 312, each for one twin 1×16 WSS. Accordingly, the interconnect chassis may comprise 16 of the 1×16 WSS card, and be referred to as 16×16 WSS. The interconnect cards may provide the interconnectivity between the at least one line chassis 302 and the at least one add-drop chassis 304 of the ROADM cluster. In some implementations, the S interconnect cards may comprise g interconnect cards, wherein each of the g interconnect cards is connected to one of the g line chassis, and h interconnect cards, wherein each of the h interconnect cards is connected to one of the h add-drop chassis. Accordingly, S=g+h, wherein g is the number of interconnect cards that connects to line chassis and h is the number of interconnects cards that connect to add-drop chassis.

On the right-side of FIG. 3, a ROADM node 350 including M interconnect chassis interconnecting g line chassis and h add-drop chassis is illustrated. The ROADM cluster node 350 may comprise m interconnect chassis that may be implemented as the interconnect chassis 306. The ROADM node 350 may further comprise g line chassis that may be implemented as the line chassis 302. The ROADM node 350 may further comprise h add-drop chassis that may be implemented as the add-drop chassis 304.

Each of the g line chassis may comprise n line cards for n incoming and outgoing fibers and m interconnect cards. Each of the h add-drop chassis may comprise m interconnect cards and n/2 add-drop cards. n/2 value may be different if the size of the add-drop card is changed, for example, if each add-drop card occupy only one slot, then each of the h add-drop chassis may comprise m interconnect cards and n add-drop cards. Each of the m interconnect chassis may comprise S interconnect cards for interconnecting each of the g line chassis and each of the h add-drop chassis.

Each of the m interconnect cards of each of the g line chassis may connect via fiber, shown as solid line, to each of the m interconnect chassis. Similarly, each of the m interconnect cards of each of the h add-drop chassis may connect via fiber, shown as dotted line, to each of the m interconnect chassis.

The ROADM cluster node architecture provides for two levels of interconnectivity. The first level of interconnectivity may be at intra-chassis or intra-connectivity level, which may be the optical backplane in each line, add-drop, and interconnect chassis as described herein. The second level of interconnectivity may be at the inter-chassis or inter-connectivity level, which may be each of m interconnect chassis, interconnecting each of the g line chassis with the each of the h add-drop chassis.

The ROADM node 350 may further comprise a cluster node controller 360, which may be referred to as a cluster controller, for controlling the operation of the ROADM node 350 as a whole. The cluster node controller 360 may be for cloud ROADM control software. The cluster node controller 360 may decide on routing and schedule of connections by maintain stats of all connections of the ROADM cluster. The cluster node controller 360 may also decide on routing and schedule of connection by communicating management messages to all line and add/drop chassis for setting up new connection, for example, from one chassis (line or add/drop) to another chassis (line or add/drop), or to release an existing connection between any two chassis of a cluster.

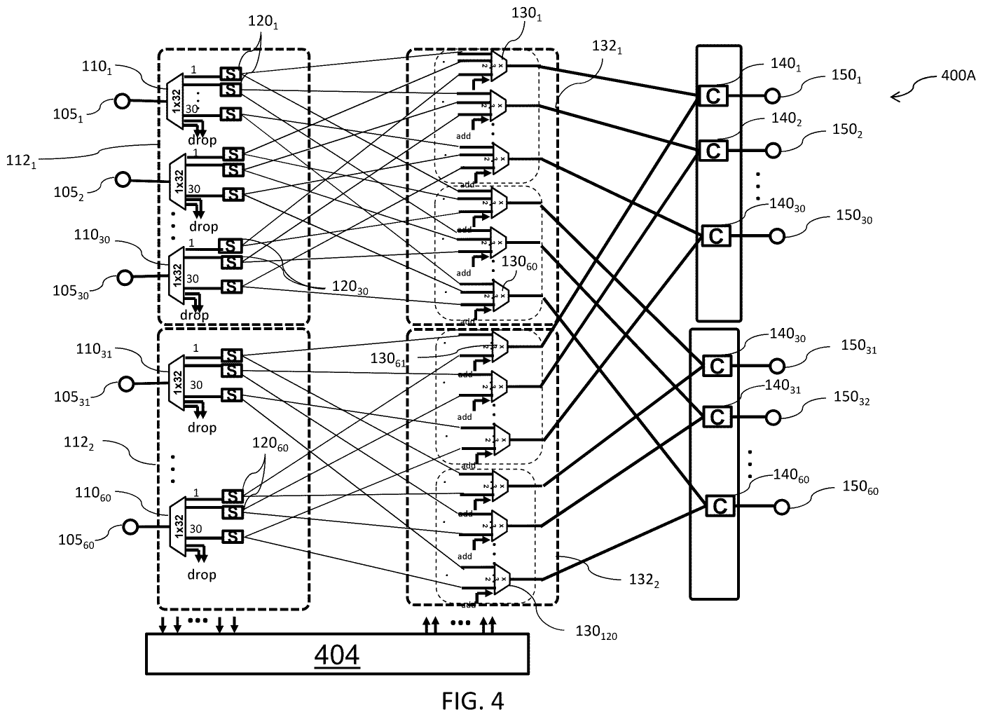

FIG. 4 illustrates an embodiment of a high degree ROADM node 400A that may provide 60 or more degrees, according to some implementations of the present technology. Implementations disclosed herein provide for a ROADM that allows for a low-cost, scalable and feasible solution for next generation of ROADMs. The ROADM may be built using one or more existing chassis, such as the chassis 100 being already deployed in an optical network. Using existing chassis allows for re-usability and flexibility offering customers the ability to pay for additional capacity as needed. Accordingly, the size can be ‘paid as grow’ with addition of a line chassis and of an add-drop chassis. The ROADM may be formulated as follows.

The ROADM is based on the separation of node functions (line and add-drop functions) that are currently performed in the same chassis, as discussed with respect to FIG. 1. The ROADM provides for performing the node functions in separate chassis, wherein each chassis performs different functions. The ROADM may have at least one chassis for line functionalities, in which the chassis may be referred to as a line chassis or a line node. The ROADM may have at least one chassis for add-drop functionalities, in which the chassis may be referred to as an add-drop chassis or an add-drop node. In some implementations, a same chassis may perform a plurality of functions (e.g. line functionalities and add-drop functionalities).

In a non-limiting example, the ROADM may further include at least one chassis, which may be referred to as an interconnect or interconnecting chassis, for interconnecting the at least one chassis (line chassis or add-drop chassis) to at least one other chassis (line or add-drop chassis). Accordingly, the inter-connect chassis may interconnect line chassis as well as line and add-drop chassis. In some implementations, there may be more than one line chassis with no add-drop chassis, in which the interconnect chassis interconnects the line chassis. The interconnect chassis may be a separate chassis on its own, separate from the line chassis and the add-drop chassis. In an alternative example, a given chassis may perform a plurality of theses functionalities such as line functionality and add-drop functionality in parallel.

Moreover, high degree ROADM disclosed herein aim to provide relatively higher degree without increasing Polarization dependent Loss (PDL) level. As will be described in greater details herein after, the high degree ROADM nodes do not need interconnect chassis, thereby providing manageability of the amount of PDL. It should be noted that, the optical signal carried in two polarization X and Y and as they pass-through the ROADM nodes each polarization suffer losses that is different from one another. As a result, it is important to use designs that minimizes the PDL

Referring back to FIG. 4, the high degree ROADM node 400A includes a first set of D optical inputs 105₁ to 105₆₀ that may receive an optical signal such that each optical input receives the optical signal. In this illustrative implementation, D equals 60, which is the number of degrees. For example, the high degree ROADM 400A may be implemented in a communication network in Toronto and may receive 15 optical signals from Vancouver, each over a corresponding optical input 105ᵢ. The high degree ROADM 400A may also receive 10 optical signals from Montreal, each over a corresponding optical input 105ᵢ, 20 optical signals from New York City, and 15 optical signals from Chicago. Hence, the optical signals received at the first set of D optical inputs 105₁ to 105₆₀ may be distinct from one another.

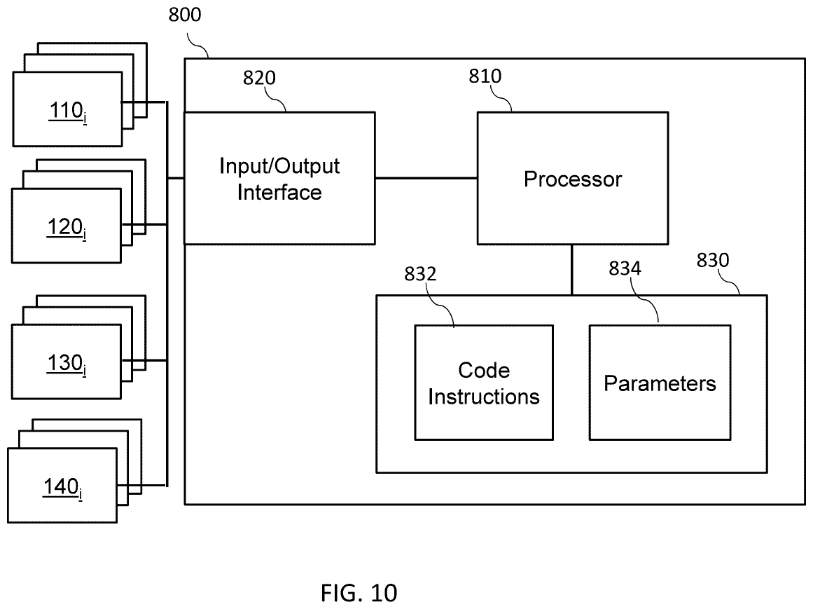

The high degree ROADM 400A further includes a first stage of D first optical switching devices 110₁ to 110₆₀. Each first optical switching device 110ᵢ is associated with a corresponding optical input 105ᵢ and receives the optical signal therefrom. In use, each first optical switching device 110ᵢ distributes wavelengths of the received optical signal over a plurality of corresponding outputs. In other words, each first optical switching device 110ᵢ switches wavelengths to each of its corresponding outputs, hence, each corresponding output carries a subset of input wavelengths received by that first optical switching device 110ᵢ. In the illustrative implementation of FIG. 4, each first optical switching device 110ᵢ has 32 outputs. As such, the first optical switching devices 110ᵢ may be referred to as “1×32” optical multiplexers. Two outputs of each first optical switching device 110ᵢ are drop output channels. The drop output channels of the first optical switching device 110ᵢ are communicably connected to an add-drop chassis 404 that, in an embodiment, may be the add-drop chassis 304 as illustrated in FIG. 3. A switching state of the first optical switching devices 110ᵢ may be controlled by a controller 800 of the high degree ROADM 400A (see FIG. 10). The controller 800 is not depicted to simplify FIG. 4. In use, each input optical signal is carried over plurality of wavelengths, and each first optical switching devices 110ᵢ distributes zero or more of these wavelengths to its outputs.

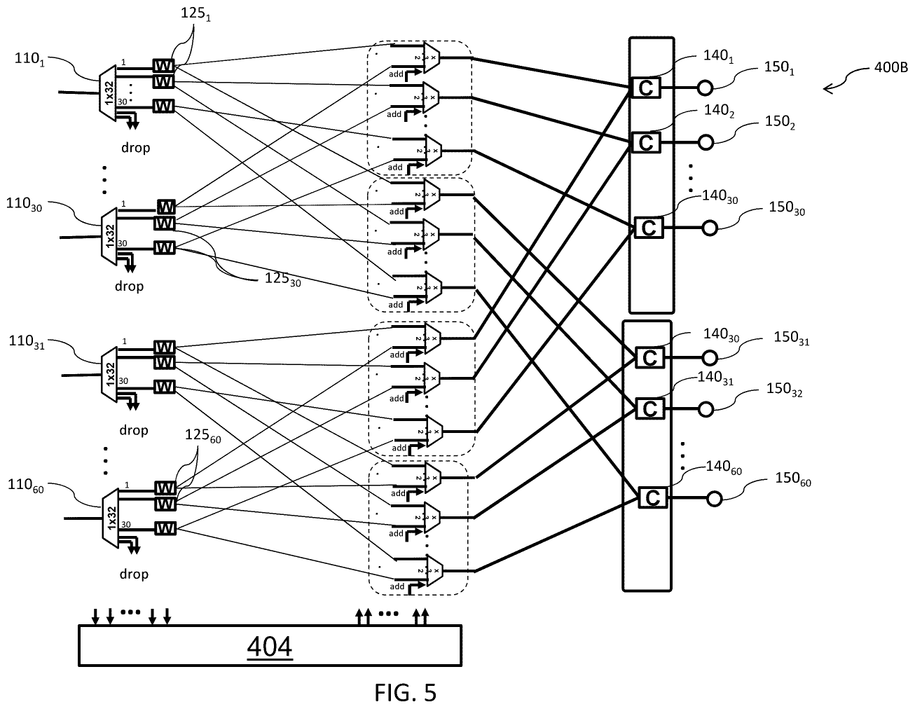

The high degree ROADM 400A further includes a second stage including a set of second optical switching devices 120₁ to 120₆₀. Each second optical switching device 120ᵢ is associated with and optically connected to one of the outputs of a corresponding first optical switching device 110ᵢ. As such, in the illustrative implementation of FIG. 4, each first optical switching device 110ᵢ is associate with 30 second optical switching device 120ᵢ, given that two of the 32 outputs of the switching device 110ᵢ are drop channels. The high degree ROADM 400A as illustrated thus includes 1800 second optical switching device 120ᵢ. In use, each second optical switching device 120ᵢ receives the optical signal (or a portion thereof) from the corresponding first optical switching device 110ᵢ and fan-out the signal into N multiple signals, where N is an integer equal or above 2. In the illustrative implementation of FIG. 4, N equals 2. For example, the second optical switching devices 120ᵢ may be optical splitters), or any other suitable optical components. Wavelength selectable switches (WSS) 125ᵢ are also contemplated, as shown in the case of the high degree ROADM 400B shown in FIG. 5. The controller 800 is not depicted to simplify FIG. 5.

Returning to FIG. 4, the second optical switching devices 120ᵢ are 1×2 optical splitters. The second optical switching devices 120ᵢ may be switching elements of 1×N (e.g. similar to the first optical switching device 110ᵢ that can switch wavelength to each of the N outputs) or splitters that split the input signal to all N output, hence, each output has all the wavelengths of the first output signal at a reduced optical power.

Broadly speaking, it can be said that D×(O−Drop)=K, where O is a number of output of each first optical switching device 110ᵢ of the high degree ROADM 400A, Drop is a number of drop output channels of each first optical switching device 110ᵢ, and K is a number of second optical switching devices 120ᵢ.

In some implementations, the second optical switching devices 120ᵢ have a pre-determined and fixed switching state. In some other implementations, the second optical switching devices 120ᵢ may be communicably connected to the controller 800 of the high degree ROADM 400A such that the controller 800 may control a switching state of each of the second optical switching devices 120ᵢ.

The high degree ROADM 400A further includes a third stage including a set of third optical switching devices 130₁ to 130₁₂₀. Each third optical switching devices 130ᵢ combines signals received from a respective M=D/N (c.g., M=30, D=60 and N=2) of the second optical switching devices 120ᵢ. It should be noted that N and D are selected by configuration of the high degree ROADM such that M is an integer. Which of the second optical switching devices 120ᵢ is associated with each third optical switching devices 130ᵢ is also determined by configuration of the high degree ROADM, according to the needs of the particular application. As can be seen on FIG. 4, full connectivity is reached given that the number of third optical switching devices 130ᵢ is a multiple of a number of first optical switching devices 110ᵢ and that each first optical switching device is connected to each sub-set (shown in dashed lines on FIG. 4) of third optical switching devices 130ᵢ of a corresponding subset 132.

Each third optical switching device 130ᵢ may include zero or more add input channels for receiving input signals from the add-drop chassis 404. In the illustrative implementations of FIG. 4, each third optical switching devices 130ᵢ includes one add input channel. For example and without limitation, the third optical switching devices 130ᵢ may be 32×1 optical multiplexers.

For a given third optical switching device 130ᵢ, a combination of the signals received from a respective M=D/N of the second optical switching devices 120ᵢ is based on a switching state of the given third optical switching device 130ᵢ. For example, in response to receiving a first signal S₁ and a second signal S₂ respectively from two given second optical switching devices 120ᵢ, a given third optical switching device 130ᵢ may provide a frequency-filtered combination of S₁ and S₂ based on the switching state of the given third optical switching device 130ᵢ. Said combination may be, for example and without limitation, a linear combination.

The third optical switching device 130ᵢ are communicably connected to the controller 800 of the high-degree ROADM 400A such that the controller may control a switching state of each of the third optical switching device 130ᵢ.

The high-degree ROADM 400A further includes a fourth stage including a set of D combining devices 140₁ to 140₆₀. In use, the combining devices 140i combine output signals of two corresponding third optical switching devices 130ᵢ of different sub-sets 132ᵢ. For example and without limitations, the combining devices 140ᵢ may be 2×1 optical combiners. Each combining device 140i transmits the combined signals to a corresponding node output 150ᵢ of the high-degree ROADM 400A. Which of the third optical switching devices 130ᵢ is associated with which combining devices 140ᵢ is also determined by configuration of the ROADM, according to the needs of the particular application. In other words, the configuration of the high-degree ROADM depends on the traffic services switched to a particular direction (i.e. a particular output 150ᵢ).

Summarily, the high-degree ROADM 400A includes 60 optical inputs (D equals 60 in the non-limiting example of FIG. 4), each first optical switching device 110ᵢ being a 1×32 wavelength selective switch including two drop output channels, 1800 second optical switching devices 120ᵢ, each second optical switching device being configured to fan-out the signal into at least two signals (N equals 2 in the non-limiting example of FIG. 4), 120 third optical switching devices 130i, and 60 combining devices 140ⱼ. As such, the high-degree ROADM 400A is a 60-degree ROADM.

As best shown on FIG. 4, in this implementation, the first optical switching devices 110ᵢ are partitioned into a plurality of sub-sets 112ⱼ (only two sub-sets 112₁ and 112₂ are depicted on FIG. 4 for clarity). In this illustrative example, the second optical switching devices 120ᵢ of a first sub-set 112₁ of the first optical switching devices 110ᵢ fan-out their signals to a first sub-set 132₁ of third optical switching devices 130ᵢ. The second optical switching devices 120ᵢ of a second sub-set 112₂ of the first optical switching devices 110ᵢ also fan-out their signals to a second sub-set 132₂ of third optical switching devices 130ᵢ. Finally, at least one of the combining devices 140ᵢ combines a first signal received from a third optical switching device 130hᵢ of the first sub-set 132₁ with a second signal received from a third optical switching device 130ᵢ of the second sub-set 132₂.

In use, the controller of the high-degree ROADM 400A controls at least the switching states of the third optical switching devices 130ᵢ to ensure that there is no duplication of same wavelengths at any of the combining devices 140i.

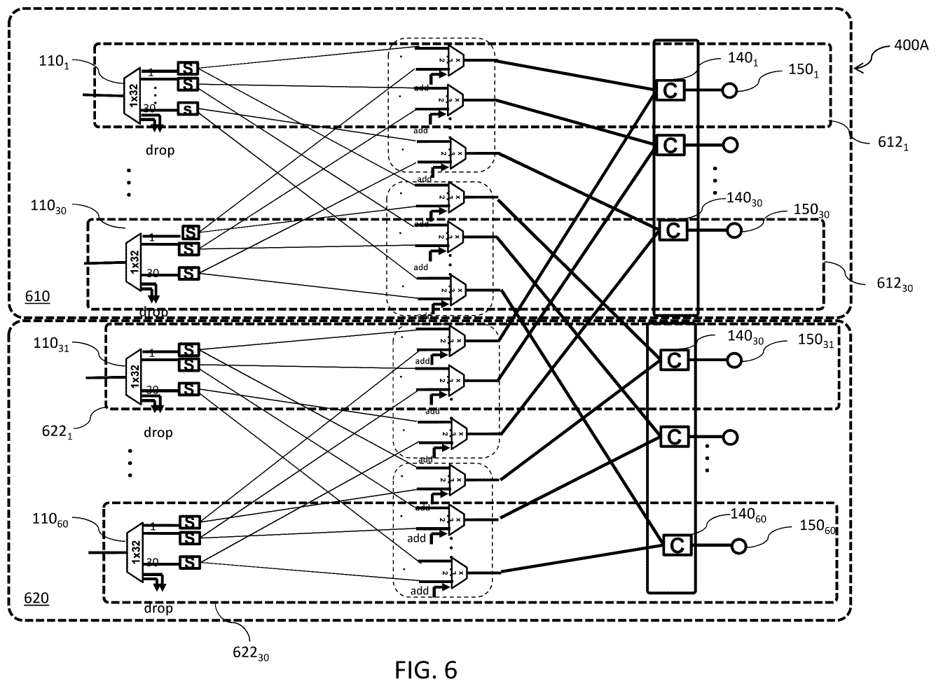

In some implementations, the first, second and third optical switching devices 110ᵢ, 120ᵢ and 130ᵢ and the combining devices 140ᵢ are implemented in optical line cards, as shown on FIG. 6. In this example, the high-degree ROADM 400A includes a plurality of chassis, only two of which being depicted on FIG. 6, for hosting the optical line cards. The add-drop chassis 404 and the controller 800 are not depicted to simplify FIG. 6. Each chassis hosts, in use, a corresponding one of the sub-sets of the first optical switching devices 110ᵢ and a corresponding sub-set of the third optical switching devices 130ᵢ. This is also applicable to the high-degree ROADM 400B.

More specifically, in the illustrative implementation of FIG. 6, the high-degree ROADM 400A includes a first backplane chassis 610 for hosting a plurality of optical line cards 612₁ to 612₃₀ including the first sub-set 112₁ (FIG. 4) of the first optical switching devices 110ᵢ. The high-degree ROADM 400A also includes a second backplane chassis 620 for hosting a plurality of optical line cards 622₁ to 622₃₀ including the second sub-set 112₂ (FIG. 4) of the first optical switching devices 110ᵢ.

Each optical line card 612ᵢ, 622ᵢ includes one of the first optical switching devices 110ᵢ, the corresponding second optical switching devices 120ᵢ, at least two of the third optical switching devices 130ᵢ and one of the combining devices 140ᵢ.

Broadly speaking, it can be said that high-degree ROADM 400A includes a plurality of optical line cards 612ᵢ where each optical line card 612ᵢ includes a given first optical switching device 110ᵢ, at least two third optical switching devices 130ᵢ receiving signals from second optical switching devices 120ᵢ associated with the given first optical switching device 110ᵢ and at least one of the combining devices. In addition, the high-degree ROADM 400A includes a plurality of backplane chassis 610, 620 communicably connected to one another, each backplane chassis 610, 620 being configured to receive a plurality of optical line cards 612ᵢ, a first backplane chassis 610 being configured to host the optical line cards 622₁ to 612₃₀ of the first sub-set 112₁ of the first optical switching devices 110ᵢ and a second backplane chassis 620 being configured to host the optical line cards 622₁ to 622₃₀ of the second sub-set 112₂ of the first optical switching devices 110ᵢ.

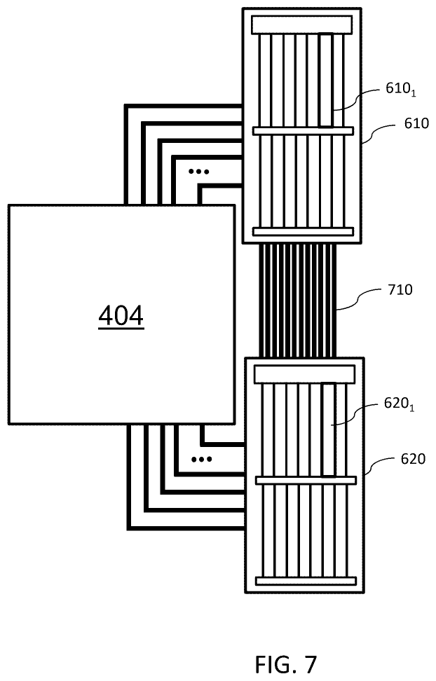

As shown on FIG. 7, the backplane chassis of the various high-degree ROADMs disclosed herein may be communicably connected together over communication lines 710 and communicably connected to the add-drop chassis 404. How the communication links between the optical line cards 612ᵢ, 622ᵢ and the add-drop chassis 304, and between the optical line cards 612ᵢ, 622ᵢ of different backplane chassis are implemented will depend inter alia on the version of the high-degree ROADMs among the different implementations disclosed herein and/or requirements of a current application thereof.

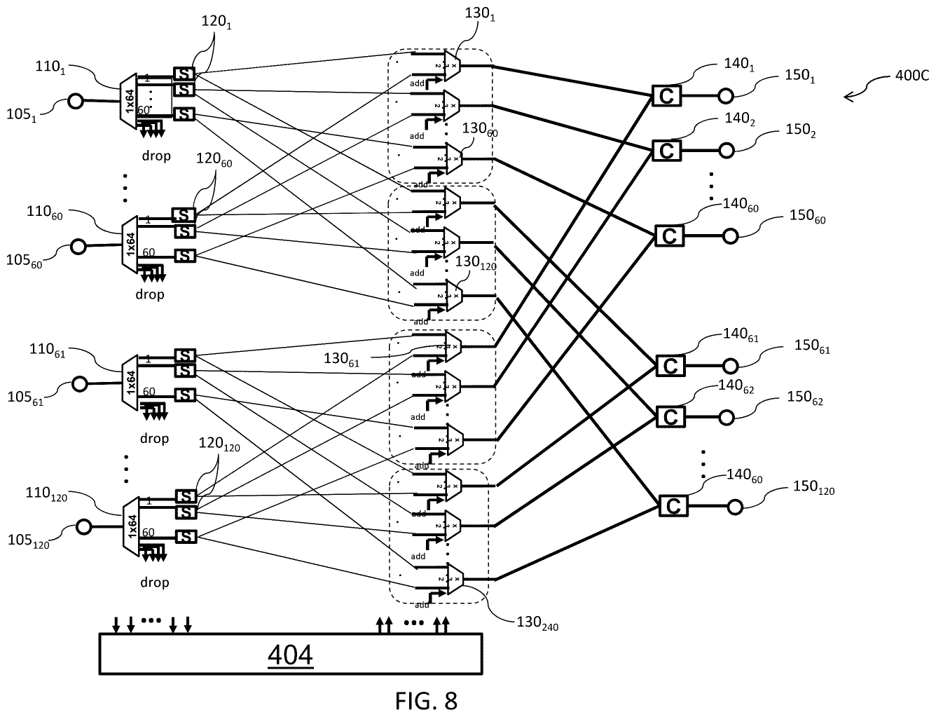

In one aspect, the present disclosure also provides a high-degree ROADM with a node degree above 60. In some implementations and as best shown on FIG. 8, a high-degree ROADM 400C includes D=120 optical inputs and D=120 first optical switching devices 110ᵢ, each first optical switching device 110ᵢ being a 1×64 wavelength selective switch including, in the no-limiting example of FIG. 8, four drop output channels. The high-degree ROADM 400C also includes 7200 second optical switching devices 120ᵢ, each second optical switching device 120ᵢ receiving a corresponding output signal from a corresponding first optical switching device 110ᵢ to fan-out said signal into two signals.

The high degree ROADM 400C also includes 240 third optical switching devices 130ᵢ, each third optical switching device 130ᵢ being a 64×1 multiplexer including two add input channels. Finally, the high-degree ROADM 400C includes 120 combining devices 140ᵢ and 120 corresponding optical outputs 150ᵢ. As such, the high-degree ROADM 400C is a 120-degree cluster node.

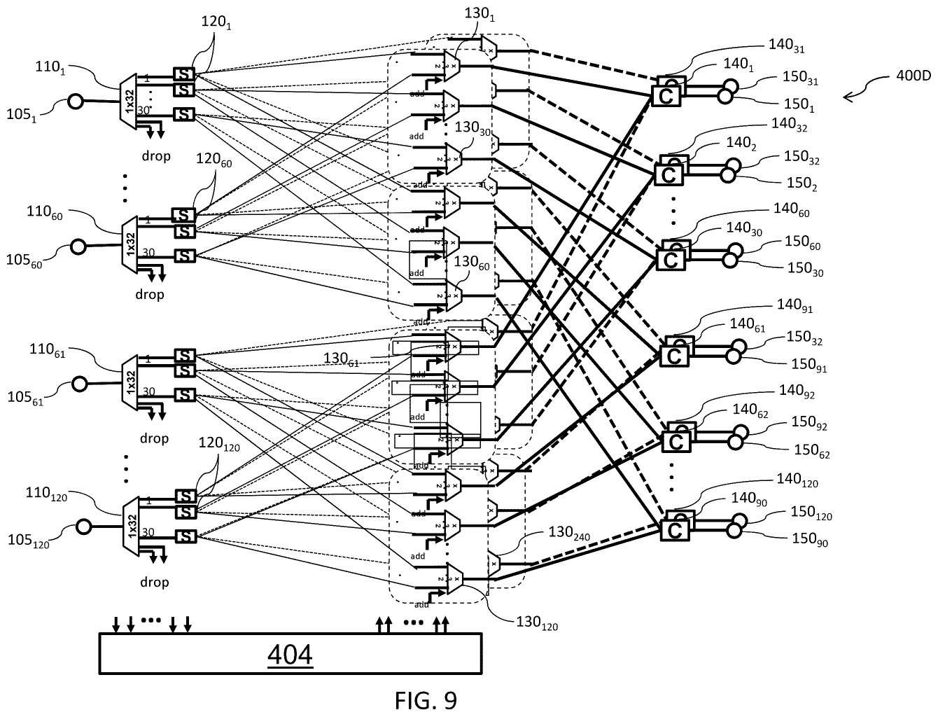

FIG. 9 shows another implementation of a 120 degree ROADM 400D. In this implementation, the high degree ROADM 400D includes 120 first optical switching devices 110ᵢ, each first optical switching device 110ᵢ being a 1×32 wavelength selective switch including, in the example of FIG. 9, two drop output channels. The high degree ROADM 400D also includes 3600 second optical switching devices 120ᵢ, each second optical switching device 120ᵢ receiving a corresponding output signal from a corresponding first optical switching device 110ᵢ to fan-out said signal into four signals. Two signals are represented by continuous lines, and the two others by dashed lines on FIG. 9.

The high-degree ROADM 400D also includes 240 third optical switching devices 130ᵢ, each third optical switching device 130ᵢ being a 32×1 multiplexer including one add input channel. Finally, the high-degree ROADM 400D includes 120 combining devices 140ᵢ and 120 corresponding optical outputs 150ᵢ. As such, the high-degree ROADM 400D is also a 120 degree cluster node.

As expressed hereinabove, each of the high degree ROADMs 400A, 400B, 400C and 400D includes the controller 800, which is communicably connected to the first, third and fourth optical switching devices 110ᵢ, 130ᵢ. and 140ᵢ to adjust a switching state thereof. In some implementations, controller 800 is also communicably connected to the second optical switching devices 120ᵢ to adjust a switching state thereof. As an example, FIG. 10 is a schematic block diagram of the controller 800 of the high degree ROADM 400A, 400B, 400C or 400D according to an implementation of the present technology. The controller 800 comprises a processor or a plurality of cooperating processors (represented as a processor 810 for simplicity), a memory device or a plurality of memory devices (represented as a memory device 830 for simplicity), and an input/output interface 820 allowing the controller 800 to communicate with other components of the high degree ROADM 400A, 400B, 400C or 400D and/or other components in remote communication with the high degree ROADM 400A, 400B, 400C or 400D. The processor 810 is operatively connected to the memory device 830 and to the input/output interface 820. The memory device 830 includes a storage for storing; for example and without limitation, pre-defined switching states of the first, third and fourth optical switching devices. The memory device 830 may comprise a non-transitory computer-readable medium for storing code instructions 832 that are executable by the processor 810 to allow the controller 800 to perform the various tasks allocated to the controller 800 for operation of the high degree ROADM 400A, 400B, 400C or 400D.

The controller 800 is operatively connected, via the input/output interface 820, to the first, third and fourth optical switching devices. The controller 800 executes the code instructions 832 stored in the memory device 830 to implement the various above-described functions that may be present in a particular implementation. FIG. 10 as illustrated represents a non-limiting embodiment in which the controller 800 orchestrates operations of the high-degree ROADM 400A, 400B, 400C or 400D. This particular embodiment is not meant to limit the present disclosure and is provided for illustration purposes.

It will also be understood that, although the implementations presented herein have been described with reference to specific features and structures, it is clear that various modifications and combinations may be made without departing from such disclosures. The specification and drawings are, accordingly, to be regarded simply as an illustration of the discussed implementations or implementations and their principles as defined by the appended claims, and are contemplated to cover any and all modifications, variations, combinations or equivalents that fall within the scope of the present disclosure.

What is claimed is:

1. A reconfigurable optical add-drop multiplexer comprising:
a first stage comprising a set of D first optical switching devices, each first optical switching device being configured to receive a corresponding optical signal, each first optical switching device being configured to distribute wavelengths of the corresponding optical signal over a plurality of corresponding outputs;
a second stage comprising a set of second optical switching devices, each second optical switching device being associated with one of the outputs of a corresponding first optical switching device and configured to receive a first output optical signal therefrom, each second optical switching device being configured to fan-out the first output optical signal into N multiple signals, where N is an integer equal to or greater than 2;
a third stage comprising a set of third optical switching devices, each third optical switching devices being configured to combine second output signals received from M=D|N corresponding second optical switching devices, a combination performed by a given third optical switching device being based on a switching state thereof;
a fourth stage comprising a set of D combining devices configured to combine, in use, third output signals of N corresponding third optical switching devices and provide a set of D optical outputs of the reconfigurable optical add-drop multiplexer; and
a controller communicably connected to the optical switching devices of the first and third stages and to the combining devices of the fourth stage to adjust switching states thereof.

2. The reconfigurable optical add-drop multiplexer of claim 1, wherein at least one of the second optical switching devices is a wavelength selectable switch.

3. The reconfigurable optical add-drop multiplexer of claim 1, wherein at least one of the second optical switching devices is an optical splitter.

4. The reconfigurable optical add-drop multiplexer of claim 1, wherein each first optical switching device includes zero or more drop output channel.

5. The reconfigurable optical add-drop multiplexer of claim 4, wherein:
D×(O−Drop)=K,
where O is a number of outputs of a particular first optical switching device, Drop is a number of drop output channels of the particular first optical switching device, and K is a number of second optical switching devices corresponding to the particular first optical switching device.

6. The reconfigurable optical add-drop multiplexer of claim 1, wherein each third optical switching device includes zero or more add input channel.

7. The reconfigurable optical add-drop multiplexer of claim 1, wherein:
the first optical switching devices are partitioned into a plurality of sub-sets,
the second optical switching devices associated with a first sub-set of the first optical switching devices fan-out their signals to a first sub-set of third optical switching devices,
the second optical switching devices associated with a second sub-set of the first optical switching devices fan-out their signals to a second sub-set of the third optical switching devices, and
at least one of the combining devices is configured to combine a first signal received from a third optical switching device of the first sub-set of third optical switching devices with a second signal received from a third optical switching device of the second sub-set of third optical switching devices.

8. The reconfigurable optical add-drop multiplexer of claim 7, further comprising:
a plurality of optical line cards, each optical line card comprising:
a given first optical switching device;
at least two third optical switching devices receiving signals from the second optical switching devices associated with the given first optical switching device; and
at least one of the combining devices of the fourth stage; and
a plurality of backplane chassis communicably connected to one another, each backplane chassis being configured to receive a sub-set of the plurality of optical line cards, a first backplane chassis being configured to host the optical line cards of the first sub-set of the first optical switching devices and a second backplane chassis being configured to host the optical line cards of the second sub-set of the first optical switching devices.

9. The reconfigurable optical add-drop multiplexer of claim 1, wherein the first optical switching devices are wavelength selectable switches.

10. The reconfigurable optical add-drop multiplexer of claim 1, further comprising:
a set of D optical inputs, each optical input being configured to receive a corresponding optical signal, each first optical switching device being associated with one of the D optical inputs and configured to receive the corresponding optical signal therefrom.

11. The reconfigurable optical add-drop multiplexer of claim 10, wherein:
the set of D optical inputs includes 60 optical inputs,
the first stage includes 60 first optical switching devices,
each first optical switching device is a 1×32 wavelength selectable switch including two drop output channels,
the second stage includes 1800 second optical switching devices,
each second optical switching device is configured to fan-out the signal into two signals,
the third stage includes 120 third optical switching devices, and
the fourth stage includes 60 combining devices.

12. The reconfigurable optical add-drop multiplexer of claim 10, wherein:
the set of D optical inputs includes 120 optical inputs,
the first stage includes 120 first optical switching devices,
each first optical switching device is a 1×32 wavelength selectable switch including two drop output channels,
the second stage includes 3600 second optical switching devices,
each second optical switching device is configured to fan-out the signal into four signals,
the third stage includes 240 third optical switching devices, and
the fourth stage includes 120 combining devices.

13. The reconfigurable optical add-drop multiplexer of claim 10, wherein:
the set of D optical inputs includes 120 optical inputs,
the first stage includes 120 first optical switching devices,
each first optical switching device is a 1×64 wavelength selectable switch including four drop output channels,
the second set stage includes 7200 second optical switching devices,
each second optical switching device is configured to fan-out the signal into two signals,
the third stage includes 240 third optical switching devices,
each third optical switching devices includes two add input channels, and
the fourth set of combining devices includes 120 combining devices.

14. The reconfigurable optical add-drop multiplexer of claim 1, further comprising an add-drop module operably connected to each of the first and third optical switching device such that the add-drop module may receive drop signals therefrom and transmit add signals thereto.
